(19) United States
(12) Patent Application Publication
(10) Pub. No.: US 2009/0131137 A1
(43) Pub. Date: May 21, 2009

(54) METHOD OF PLAYING POKER

(76) Inventor: Leonard Barshack, Ketchum, ID (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/343,607

(22) Filed: Dec. 24, 2008

Related U.S. Application Data
(62) Division of application No. 11/315,780, filed on Dec. 21, 2005, now abandoned.
(60) Provisional application No. 60/638,321, filed on Dec. 22, 2004.

(51) Int. Cl. A63F 13/00; A63F 9/24

(52) U.S. Cl. 463/13; 463/42; 463/25

(57) ABSTRACT

The invention comprises multiple methods for playing a game of poker over a communication network such as the internet which are simple and easy to learn. In a first method, all participants place bets of equal value into a pot with no additional opportunities to raise or place additional bets. In a second method, players are provided with an option to place bets on various rules of winning, wherein bets are paid depending on the outcome of the three-card flop. In a third method, players are presented with timed intervals during which players can place a fixed bet into the pot to be eligible to stay in the hand. Significantly, all players decide whether to place additional bets simultaneously or during the same time interval rather than sequentially as is done in traditional versions of poker.

### RELATED APPLICATION

This application is a division and claims priority of U.S. application Ser. No. 11/315,780, filed on Dec. 21, 2005, now abandoned, the content of which is incorporated herein by reference. Application Ser. No. 11/315,780 claimed the priority of U.S. Provisional Application Ser. No. 60/638,321, filed on Dec. 22, 2004, which is also incorporated herein by reference.

### FIELD OF INVENTION

This invention relates to a method of playing a game of cards. More specifically, this invention involves variable methods of playing a game of poker for avid players and novices alike, thereby providing more excitement and enjoyment to poker players of all different skill levels.

### BACKGROUND OF THE INVENTION

Although the origins of the variety of poker known as “Texas Holdem” are unclear, nowadays it appears to be the most common style of poker that is played. Players of this style of poker are invariably passionate about playing the game itself as well as eager to access a collection of educational resources in order to improve their Texas Holdem poker skills. Other forms of poker, including Omaha and Seven Card Stud, have likewise become very popular in recent years. When playing these forms of poker, players may gather in casinos or other gaming establishments for purposes of “winning it big,” or they may play in a casual game at a friend's house on what has come to be known in many circles as “poker night.”

Whether in a casino or casual setting, players can play in “money games,” where players can leave the table during play with the chips that they possess at any given time, or they may play in tournaments where the objective is to be the last player standing after having acquired all the chips played at the tournament. Of course, different types of money games have different rules, as do different forms of tournaments. Furthermore, while there are different strategies associated with money games and tournaments, the objective is the same—to win.

Another facet of the various games of poker is the advent of online poker websites where players gather from all over the world to participate. Many of the well-known online poker sites provide simulated table environments for both “real money” and “play money” versions of poker, typically with up to ten players participating at any given table. In the context of both real and play money poker, individuals can choose to participate in both “money games” and tournaments. Furthermore, online poker permits players to play at more than one table at once by simply maintaining a separate window for each game.

While participating in online poker eliminates the capability of players to observe their opponents in a live setting, it provides computer users, who may otherwise not have the opportunity to travel to a casino, with relatively easy access to the game. Indeed, purists contend that removing the ability to analyze and observe the idiosyncrasies and reactions of opponents makes the game less “real.” Nevertheless, the anonymous character of online poker may be a major reason why the game has become so popular, inasmuch as it allows participants to play from the comfort of their own homes, twenty-four hours a day, seven days a week, with relatively little hassle. Furthermore, unlike live poker, since online poker players compete over a computer network, the game has been adapted to give players certain options that are not available in a live game, such as the ability for players to “call” or “fold” even before it is their turn to make a play.

Notwithstanding the current popularity of poker, whether in a live or online setting, poker has always been considered a game which requires a high level of skill (even though luck obviously plays a role in a player's success on any given occasion). Thus, players who are deeply interested in participating often find themselves abstaining from play as a result of the perception that they do not possess the requisite skills to play with “seasoned” or even marginally experienced players. These non-participants typically prefer either to play online with “play money” or watch other players compete against each other in casinos, online, or on television in “real money” games.

Another shortcoming with respect to the game of poker is that it requires players to maintain a high level of vigilance and attention at all times. With respect to beginners, who are attempting to absorb the basic rules as well as the intricacies of the game, this is especially difficult. Furthermore, even for experienced players, having to stay alert poses a considerable dilemma, particularly after many uninterrupted hours of playing without rest. Often times, players who are fatigued lose concentration and become impatient, causing them to make poor decisions during the course of play. Nevertheless, notwithstanding the mental demands of the game, these players simply continue to play, without realizing that they might be better off either playing another less mentally challenging game or simply taking a break.

A further deficiency in the game of poker is that players who decide to fold before the end of the hand must endure long stretches of time waiting for the start of the next hand. This lends itself to increased impulsiveness and poor play. While the problem of waiting between hands is somewhat alleviated by online poker sites which allow participants to play at multiple tables simultaneously, playing at multiple tables prevents participants from concentrating on opponents at a given table, thereby forcing participants to undesirably spread their attention beyond optimal levels.

In addition, at casinos and other gambling establishments, poker does not provide for significant profits (relative to other table games such as blackjack and roulette). In the context of “money games,” casinos simply earn money based on the amount of chips which are present in any given pot. Typically, with each round of betting, the casino, house or house representative (i.e., the dealer) will set aside a “rake,” or a percentage of the total bets by the players for itself. On the other hand, in tournament-style games, casinos earn money based on a flat registration fee paid by each participant before the start of the tournament. In both money games and tournaments, the house does not risk losing any money to the players. However, the rake-percentages or tournament fees which are earned by the house are significantly limited.

Likewise, even in the context of online poker, where the number of tables at a website is not limited by physical space (as in a live gaming establishment), the rake-percentages and tournament fees are also limited. In this setting (as in a live setting), there is an untapped potential for adapting the game of poker for purposes of providing added revenues to proprietors of gaming institutions.

### BRIEF DESCRIPTION OF THE INVENTION

In view of the prior art deficiencies, the principle objective of the present invention is to provide variable methods for playing a game of poker for both experienced players and beginners for purposes of providing excitement and opportunity to players of diverse skill levels.

Another objective of the present invention is to provide a method for playing poker for purposes of embracing novices and less experienced players who otherwise would abstain from playing as a result of the perception that they are inadequately skilled in the game of poker.

A further objective of the present invention is to provide a method for playing poker which permits amateur poker players to compete against proficient players on a level playing field. In connection with this objective, a method described herein provides for transforming traditional games of poker that typically require a minimum amount of skill into a game of fixed odds wherein each participant generally has the same chance of winning as the next.

Another further objective is to provide a method for playing poker which preserves the fun and excitement of the traditional game of live or online poker but which is less mentally demanding.

A still further objective is to provide a method for playing poker which provides poker players with an alternate outlet for playing poker during periods of physical or mental fatigue, thereby allowing them to continue to play poker with reduced adverse affects.

An additional objective is to provide a method of playing poker which significantly decreases the amount of time that players must endure until the start of the next hand at any given table.

A yet further objective of the present invention is to provide a method of playing poker which provides casinos and live or online gaming establishments with added sources of revenue.

In its broadest aspects the invention comprises multiple methods for playing a game of poker which are simple and easy to learn. Importantly, each of the methods described herein are less complicated than traditional poker games such as Texas Holdem, Omaha and Seven Card Stud, yet have the capacity to elicit an increased amount of enthusiasm and pleasure for proficient players and novices alike.

With respect to each of the methods discussed herein, the number of cards dealt to each participant is the same as in traditional poker games. However, whether the cards are dealt face up or face down may be altered as desired. Thus, for Texas Holdem poker, two initial cards are dealt to each player (traditionally these are dealt face down), followed by the “flop” comprising three community cards, followed by a fourth community card or “turn” and then followed by a fifth community card, commonly called the “river.” With respect to Omaha poker, each player is first dealt four initial cards (traditionally these are dealt face down), followed by a flop, then a turn card and then a river card as in Texas Holdem. In Texas Holdem and Omaha, players may use the community cards plus their own initial cards to make the best possible five-card hand. Seven Card Stud is also dealt traditionally, wherein each player receives three initial cards (traditionally two are dealt face down, one face up), followed by four cards dealt sequentially (the first three face up and the last face down) to each of the players. Ultimately, as in traditional games, the player having the best five-card hand wins the pot.

Notwithstanding the similarities with respect to the traditional number and method for the dealing of the cards, the methods described herein are distinct and designed to significantly reduce the requisite skill and focus that are generally required to excel at traditional versions of these games.

In a first method, all participants place bets of equal value, and the bets are pooled into a pot. Thereafter, the cards are progressively dealt as they are normally, being displayed to each player, and the player with the best five-card hand is awarded the pot. It should be understood that cards are not required to be dealt progressively (i.e., one after the next), particularly in the context of practicing the methods over a communication network, since one or more cards can be dealt to more than one participant at the same time. Furthermore, while bets are typically pooled into a “pot” during the course of a given hand, the bets are not required to be placed into a “pot” and bets may be allocated at the conclusion of a hand. In the event that two players have the best five-card hand, the pot is split between the two. Significantly, players are not given an opportunity to “raise” or place additional bets, and the final total of the pot is limited to the total amount of bets that were initially placed. It is to be understood that while the number of cards that are dealt to players is the same when practicing this first method, the initial number of cards to the participants may be dealt either face up or face down. When dealt face up, the method lends itself to the opportunity for tutoring players in the game.

In a second method, during the course of play at a given table, players are provided with an option to place side bets or bets on various rules of winning, wherein the bets are paid depending on the outcomes of the three-card flop. Thus, for example, players can place a bet that at least two of the three cards dealt on the flop will be diamonds or hearts, that all three cards will be spades or clubs, that all three cards will be hearts or diamonds, that the flop will include a pair or three of a kind or any other variation involving a combination of suits and/or denominations of the cards (i.e., three, jack, ace etc.). In the course of play, players may be given the opportunity to place a side bet that is linked to the product or outcome of the flop. The opportunity to place a side bet may be provided to players before the hand commences (i.e., during a prior hand) or at any time before a flop upon which a side bet being made is dealt. Even players who do not participate in the hand itself may place a side bet on the product of the flop.

In a third method, all participants at a given table place a first ante bet earning them the right to receive an initial number of cards. After the initial number of cards are dealt, there are four intervals during which players decide whether to place additional fixed bets (a second, third, fourth and fifth bets) in order to be eligible to proceed further in the game. All players choose whether to place additional bets during the same time interval rather than sequentially as is done in traditional versions of poker. In addition, since all players must decide during the same time interval, this method lends itself more to online play where other players do not know whether their opponents intend to place a bet or not. Significantly, a player has decided whether or not to place an additional bet without knowing whether the other players have decided to bet or not to bet. An indication or display of which players have chosen to bet and continue (and/or not to bet and fold) is provided after all players have made their decision. Each of the foregoing three methods discussed above may be modified or adapted to provide for supplemental or different types of bets. Likewise, particularly with respect to online poker, players who are not actually “sitting” at a table may place bets on other players' hands or on the outcome of the flop as discussed above. Furthermore, each of the foregoing three methods may be adapted to provide for increased revenues for casinos and gaming establishments, whether in the form of a “tax” or “rake” or simply by the casino taking on the risk and formulating payouts which are less than the true odds for any given outcome (as is typically done in the context of the games of craps and roulette). Also, the foregoing methods may be adapted to either tournament or money games. Significantly, it is to be understood that while some of the methods described herein are described in the context of an online gaming environment, casino or through Interactive Direct TV (iDTV), these are merely demonstrative of such “venues” wherein the methods may be practiced and it is to be understood that the locations for practicing these methods are not limited as such. Thus, in addition to practicing these through any communication network such as the internet in a virtual casino, iDTV, or in traditional casinos, the methods may also be practiced on cellular or mobile telephones, WiFi, and other digital formats or communications networks as well as in combinations of all of the foregoing.

### DETAILED DESCRIPTION OF INVENTION

Various methods for playing a game of poker are discussed herein. Each of the following methods will be discussed individually, including a number of variations which can be incorporated into each method.

### Method One

With respect to the first method, the simplest form requires at least two participants. Each participant places a first bet or ante comprising equivalent sums of money. Significantly, subsequent to the placement of the first bet, there is no additional betting by the participants. After the first bet is made, cards are dealt to the end as is performed in traditional forms of poker. Accordingly, in the context of Texas Holdem, the participants are dealt an initial two cards face down, followed by a flop of three community cards, followed by the turn comprising one community card and concluding with the river which likewise comprises one community card. In the context of Omaha, the only difference is that participants are initially dealt four cards face down rather than two. With respect to Seven Card Stud, players are dealt two cards down, one card up for a total of three cards, followed by three cards dealt face up and one final card that is dealt face down. At the conclusion of the dealing, the players show their cards and the player with the best five-card poker hand wins the total of all of the ante bets. If multiple players have the same best hand, the pot is divided between them. Of course, since no additional bets are made, this method may be modified such that all cards are dealt face up after the ante bet is placed.

An example of the foregoing comprises four players seated at a Texas Holdem table. All players who choose to play place an ante bet of $25 each. After each of the four players place the ante bet, there is a total of $100 in the pot. Thereafter, the dealer distributes the entire hand in sequence as a dealer would during a conventional game of Texas Holdem. After the cards are dealt, the players can either choose to “muck” or “show” their cards, and the player(s) with the best five card hand is awarded the pot.

The number of participants that may play according to this method is limited by the number of cards in a playing deck. However, a table typically seats up to ten players for Texas Holdem and Omaha and six players for Seven Card Stud.

When this method is played in a casino environment, the casino, “house” or house representative may set aside a “rake” from the pot from three to ten percent before awarding it to the winner. Thus, if there is a total of $100 in the pot, the house would keep $3 to $10 and the winning player would receive $97 to $90. In this version, the house would assume no financial risk since it receives money regardless of which player wins. Of course, the rake may be modified to be less than three percent or more than ten percent as desired. Furthermore, while this may be compared to the limited rake that is taken in traditional poker games, considering the relative simplicity of the game and, more importantly, the lack of multiple rounds of betting which can take a lot of time, more hands can be dealt over any given time span, providing for more rakes which can be taken by the house, thereby increasing revenue. It should be understood that in practicing the methods described herein, particularly in the context of the internet or other communications networks and the like, that a “house representative” is not limited to and does not necessarily require a human being and is intended to encompass all those actions performed by a human being in a physical gaming environment.

Likewise, in the context of a casino environment, the first participant (of the two minimum participants) may be a casino patron, while the second can be the casino itself. Accordingly, this method can be played with only one player and a house. In this variation, the casino assumes some risk since it may lose to the player. However, this risk may be minimized by the casino paying out somewhat less than even money, or keeping a percentage of the pot, in the event that a player defeats the casino.

In addition, the method may be modified such that each participant may be given an opportunity to assume the risk of losing individually to each of the participants at a table. Thus, for example, where there are four participants, Players A, B, C and D, instead of awarding the collective pot to the best hand of all four players, Player A can choose to play against Players B, C and D and thus be required to pay winnings to Player B, Player C and/or Player D when Player A's hand is worse than one or all of the other players' hands, or taking the bets of one or more of these players when Player A's hand is better. Thus, this method as modified allows for a player taking individual risk of having to pay all the players at a table. In this method, each of the players may be given a turn to do so by passing a “shoe” or marker around the table from player to player. Likewise, in this variation, the house may or may not play and/or take a percentage of winnings.

In another variation of this method, players are free to place first ante bets of different amounts (again, with no additional bets being placed after the first ante bet). In this variation, a number of “pots” can be created depending upon the number of participants in a given hand and the number of different ante bets that are placed by the participants.

An example of the foregoing variation comprises five players seated at a Texas Holdem table, wherein Player A bets $10, Player B bets $20, Player C bets $20, Player D bets $25, and Player E bets $100. Based on this scenario, the first pot has $10 from each player and hence totals $50, and it is awarded to the best hand among Player A, Player B, Player C, Player D and Player E. The second pot contains the remainder of Player B's and Player C's bets, totaling $20, as well as $10 each from Player D's and Player E's bets. Therefore, the second pot contains a total of $40 and is awarded to the best among Player B, Player C, Player D and Player E. The third pot merely contains the remainder of Player D's bet totaling $5 with an equal amount from Player E's bet. This pot is awarded to the best hand among Player D and Player E. Player E gets $75 returned.

In this variation, a table can incorporate a minimum and maximum bet. Alternatively, a table can be designated a “no limit” table, where a player is permitted to bet all the money accompanying the player to the table. Furthermore, the house has no risk in this variation, insofar as it is played between players. Also, the amount of the ante bet can be placed in sequence starting from a “button” or designated marker or can be placed as players are ready to bet.

As described above, a casino or online gaming establishment that is willing to assume some risk may take a position at the table where it is dealt cards as any other participant. In this variation, instead of players playing against each other, all of the players play exclusively against the house. This game may require fixed betting where every player at the table antes the same amount. However, it is much more interesting to have a table minimum/maximum betting limit as casinos typically institute for other table games. Also, as mentioned above, the casino may “tax” a player every time the player wins to minimize the risk. A typical amount may be a five percent tax, but this amount may be varied.

Interestingly, this variation also lends itself to “back betting,” where bettors can “back” any one or more of the positions at a given table. Further, more than one person can back a particular position. Thus, in a table comprising nine positions (and a dealer), Bettor A can back each of the nine positions for $10 each, or $90 total, in the hope that all nine players' hands will beat the dealer's hand. Also, Bettor B can back the fifth player's position for $50 and simply root for the fifth player to defeat the dealer.

When this variation is played and more than one person can place a bet on a particular position, the game should probably be played electronically over the internet, cellular phone, iDTV, WiFi, digital formats, or other types of communication networks and the like where one table could handle an unlimited number of bettors. This would create a sense of community where masses of players could share in a winning streak against the house.

In another variation of this method where back betting is incorporated, bettors can place a bet behind any one (or more) of the positions. If a bettor has backed the winner of the hand, the bettor would receive an award multiplied by a factor equal to the number of positions which are being played. Thus, a participant plays both against the house and against the player's opponents.

In this variation, as in the foregoing, the house assumes risk by virtue of the fact that it can lose to a player. This risk, however, is minimized by the “tax” that may be taken by the house when the player beats the house. Also, if the game is played electronically over the internet, cellular phone, iDTV, WiFi, digital formats and the like, one table could handle an unlimited number of bettors. This would create a sense of community where masses of players could share in a winning streak.

In yet another variation of this method, a player assumes the role of the house. In this adaptation, a first player, referred to as the “mock dealer” or Player A, posts a fixed amount of money which dictates the maximum that the mock dealer can lose. Accordingly, on a table having a mock dealer and four other players, Player B, Player C, Player D and Player E, Player A deals the hand and Players B, C, D and E each post an ante. After the cards are dealt, each of the hands of Players B, C, D and E are evaluated against Player A's hand. If Player A's posted sum of money is depleted during the evaluation/payout process, all subsequent contests are ignored between Player A and the remaining players. In particular, if Player A loses all his committed money to Player B, then there is no action, win or lose, against Players C, D or E. This result can be ameliorated by limiting the posted bets of Players B, C, D and E to the maximum amount posted by Player A, or by requiring Player A to post an amount equal to the combined bets of Players B, C, D and E.

After Player A's deal is complete, Player B then becomes the mock dealer and so on and so forth.

In this variation, a house can also tax winnings as in the previously discussed variations of this method.

Moreover, this variation may be played where players have an option to deal. In such a variation, the house must also play and therefore it assumes risk. Of course, when the house deals it naturally covers all bets. The dealer rotates and passes by all players who choose not to deal.

Significantly, all of the foregoing variations of this method may be adapted to tournament play, where players would “buy” chips and continue playing until one player possesses all of the chips played at the tournament.

As evident, this method transforms traditional games of poker where skill is a factor in determining the outcome into a game of fixed odds where a player only decides to play, but makes no other significant decisions during the course of the game and each participant has the same chance of winning a given hand as the next, without any regard to skill level. Thus, once a player places a bet, a dealer merely deals a hand according to rules of a particular game that is being played and the player makes no further decisions. Significantly, other traditional games such as pai gow poker and blackjack (and the many variations of blackjack) may likewise be modified to provide for the dealing of cards to a player according to a specific set of rules, where the player is not given the opportunity to make decisions during the course of a given hand which alter his chances of winning. Thus, just as a dealer dealing a hand of blackjack must hit until reaching the count of 17 and must stay once that count is reached, a method may be utilized wherein a player is not permitted to make choices during a given hand of blackjack (unlike current versions of the game) which would alter the player's chances of winning (i.e., player must hit until the count reaches 17 and may not hit once 17 is reached; player always splits aces and eights but may not otherwise split like cards; player always doubles down on a combined two-card count of 11 where one of the cards is not an ace, but may not otherwise double down; player may not insure a hand when an ace is showing etc.) Since a player's odds of winning in certain instances may be reduced as a result of some of the “rules” noted above (i.e., not being permitted to double-down unless the combined card count is 11), the odds may be shifted back somewhat into a player's favor by providing for a payout of greater than 3 to 2 when a player reaches 21 with only two cards. Other ways of shifting the odds in a player's favor may be provided as well.

### Method Two

When an online or live poker game is being played, there is typically a significant period of time (i.e., approximately one minute) during which players must wait for the next deal of the cards. In a second method for playing poker, players are given an option during this waiting period to place side bets, proposition bets or bets on a number of “rules of winning,” comprising one or more of a number of different wagers which players place on a possible outcome of a three-card flop. Generally, these side bets are forfeited or awarded to the house if the possible outcome upon which a side bet is placed does not correspond to the three-card flop, but players are awarded if the possible outcome upon which a side bet is placed does corresponds to the three-card flop.

In this method, players place bets on various possible outcomes or rules of winning before a given flop. Optionally, these bets are placed either before or after players are dealt their initial number of cards, but in either case, bets must obviously be made before a flop is dealt. If players are permitted to place bets on a flop of a given hand after seeing the initial number of cards are dealt, players would have an advantage, having the knowledge of at least some of the cards that cannot appear on the flop. Accordingly, the placement of bets should be limited to a time before the initial number of cards of a hand are dealt. Further, players who are participating in a hand that is taking place or merely observing a hand at a given table may be given the opportunity to bet on the outcome of the flop in the following hand. In the event that there is a flop, players are paid if a bet has been placed on a rule of winning that corresponds to the flop.

Examples of rules of winning include the following permutations of cards comprising the flop: (1) two of three cards of the flop are hearts or diamonds-“mostly red”, (2) two of three cards of the flop are clubs or spades—“mostly black”, (3) all three cards are hearts or diamonds—“all red”, (4) all three cards are clubs or spades—“all black”, (5) two of three cards make up a pair of cards having an equivalent numerical denomination (i.e., any pair such as twos, threes, fours, jacks, aces etc.), (6) two of three cards have an equivalent denomination of a particular value (i.e., pair of aces only), (7) all three cards have an equivalent numerical denomination (i.e., any three-of-a-kind, “set” or “trips”), (8) all three cards have an equivalent denomination of a particular value (i.e., three-of-a-kind aces only), (9) flop comprises either a pair or a three-of-a-kind, (10) flop comprises all three cards having the same suit, (11) flop only comprises cards of a suit that is pre-selected by a player, (12) flop comprises at least one card that is pre-selected by said player. The last rule of winning is slightly different than the other listed rules of winning in that a player is given the choice of which cards to select. Mathematically, it does not matter since payouts can be modified accordingly. Of course, a number of other permutations are possible as well.

The awards or payouts for the foregoing rules of winning may generally conform to the true odds for each of the outcomes (except perhaps when the odds are very high for purposes of avoiding having to furnish a large payout). Accordingly, payouts may be in a ratio of 1:1 for bets that are placed on individual rules of winning comprising a permutation where two of three cards of the flop are either red or black. As shown in Table 1 below, in this situation, the odds may be tilted somewhat in favor of the house (rather than even odds) by providing that if, for example, an ace of hearts is the first card of the flop, the player actually loses the bet even if at least two of the three cards are red. Another example for tilting the odds in favor of the house is providing that if an ace of hearts or ace of diamonds is the first card, then the player pushes (i.e., neither wins nor loses) even when two of the first three cards are red. Of course, any card(s) may be designated in place of the ace of hearts and ace of diamonds and similar parameters may be used for the rule of winning that requires a flop having two of three cards that are clubs or spades. For rules of winning or side bets requiring that all three cards be either red or black, the payout may be in a ratio of 8:1. For the rule of winning requiring either a pair or trips, the payout may be in a ratio of 8:1 if a pair appears in the flop and 25:1 if three-of-a-kind appears in the flop. For the rule of winning requiring only trips, the payout may be in a ratio of 400:1 (although the odds are somewhat higher). For the rule of winning requiring only trips in a particular numerical denomination, such as aces, the payout may be in a ratio of 5000:1 (although the odds are somewhat higher). For the rule of winning requiring all three cards of the same suit, the payout may be in a ratio of 5:1 if the flop comprises all diamonds, 10:1 if the flop comprises all hearts, 15:1 if the flop comprises all clubs and 40:1 if the flop comprises all spades. In this rule of winning, the player may choose the suit. Of course, with respect to this particular rule of winning, the payout may also be modified to provide for the same ratio regardless of the suit. In addition, the game can also be modified to provide for bets and payouts based on four or all five of the community cards that are dealt.

Below is a table of approximated odds for drawing selected permutations of cards on the flop, along with proposed payouts for each of said permutations. Payouts can be adjusted to provide for paybacks of less than 100%.

TABLE 1

| Rule of Winning/Side Bet/Proposition Bet | Odds | Payout Ratio | Payback |
|---|---|---|---|
| At least two of three cards are red. (If first card of flop | 48.08% | 1:1 | 96.15% |
| is ace of hearts, player loses even if at | | | |
| least two of three cards are red; or, if first card of | | | |
| flop is red ace, player pushes even if at least two | | | |
| of three cards are red.) | | | |
| At least two of three cards are black. (If first card | 48.08% | 1:1 | 96.15% |
| of flop is ace of spades, player loses even if at | | | |
| least two of three cards are red; or, if first card of | | | |
| flop is black ace, player pushes even if at least | | | |
| two of three cards are black.) | | | |
| All three cards of flop are hearts or diamonds | 11.76% | 8:1 | 94.12% |
| All three cards of flop are spades or clubs | 11.76% | 8:1 | 94.12% |
| Any pair | 11.29% | 8:1 | 90.35% |
| (bonus for three of a kind) | (.024%) | (25:1) | (5.88%) |
| Any three of a kind | 0.24% | 400:1 | 94.12% |
| Three aces (or three of a particular kind) | 0.02% | 5000:1 | 90.50% |
| All three cards are of the same suit | 5.18% | 18:1 | 93.18% |
| Ace of hearts or Ace of spades is the first card | 3.85% | 25:1 | 96.15% |
| All Spades | 1.29% | 70 | 90.59% |
| All diamonds; all hearts; all clubs or | 1.29% | 10:1 | 12.94% |
| all spades (bonus) | 1.29% | 10:1 | 12.94% |
| | 1.29% | 10:1 | 12.94% |
| | 1.29% | 40:1 | 51.76% |
| All diamonds; all hearts; all clubs or | 1.29% | 5:1 | 6.47% |
| all spades (bonus) | 1.29% | 10:1 | 12.94% |
| | 1.29% | 15:1 | 19.41% |
| | 1.29% | 40:1 | 51.76% |
| Three cards in a row ascending order | 0.58% | 160 | 92.67% |
| (i.e., 4-5-6) | | | |
| Three cards in a row in ascending or descending | 1.16% | 80 | 92.67% |
| order (i.e., 4-5-6 or 6-5-4) | | | |

Optionally, in an environment such as the internet, cellular phone, iDTV, WiFi, digital formats, communication networks and the like, players may deposit money into an account and place bets that are funded by the money deposited into the account. In turn, if a rule of winning is met by a particular bet corresponding to the outcome of the flop, a player's account is credited accordingly. In addition, players may also be given an option of “activating” a bet on one or more rules of winning which remains active until the bet is “deactivated,” or until the funds in the account are exhausted. In addition, a bet can be activated for a pre-determined number of hands. Further, in the context of standing bet(s) which are in effect for an indefinite number of hands, the game may continue without interruption by providing for a change of the standing bet(s) during the period of time when a particular hand is in progress (i.e., after the flop and before the river).

Based on the foregoing method, a player can avoid being impulsive and forced to play a poor hand which often results from concern that the player will be unoccupied until the next hand since the play of this method would keep the player involved and occupied for a longer period of time.

### Method Three

Players are required to place a first bet or ante bet, after which an initial number of cards are dealt. After the initial number of cards is dealt to each of the players, the players are given a time limit or interval for placing a second bet of a fixed amount. After the time limit expires, all players who placed the second bet are eligible to continue onward to see the three-card flop, as in Texas Holdem or Omaha. Then players are given a time limit to place a third bet, after which all players who do so are eligible to continue participating to see the fourth card or turn, after which the same is repeated for the fifth card or river. Significantly, a player has decided whether or not to place the additional bets after the ante bet without knowing whether the other players have decided to bet or not to bet. An indication or display of which players have decided to bet and continue (and/or not to bet and fold) is provided after all players have made their decision and/or after the time interval has expired. Optionally, the indication may be made before the expiration of the time limit if one is put in place, so long as all players have made their decision on whether to place the additional bet or to not place the additional bet and fold.

After the river card, players are given the option of placing a final bet. If at any point during the hand there is only one player who has elected to place a bet (whether the second, third, fourth or fifth), that player wins the pot, comprising all of the previous bets. If there are two or more players who have continued to the end and placed the fifth bet, the player with the best hand takes the pot.

The declaration of the best hand may be made in one of two forms. In the first form, all players who are still in the game simply turn their cards face up at the same time. In the second form, players turn over their cards in sequence, starting from the left of the dealer. In the second form, a dealer button is required to keep place of who must turn their cards face up first. Of course, this method may also be used in the context of other poker games in which there is no flop, including without limitation, Seven Card Stud, wherein the rounds of betting may be the same as in the traditional version of the game that is being played.

This method is more suited for online play or over a communication network since it would be difficult to have everyone bet at the same time in a live game. Also this game may be modified to a tournament format wherein a group of participants may play until one (or a selected group) remains.

Although the invention has been described with reference to particular embodiments, methods and variations thereof, it is to be understood that these are merely illustrative of the application of the principles of the invention. Thus it is to be understood that numerous modifications may be made in the invention and other arrangements may be devised without departing from the spirit and scope of the invention.

1-49. (canceled)

50. A method of playing a poker game over a communication network with a plurality of players comprising the steps of:
placing a first bet into a pot by each of said players;
dealing one or more cards for said players;
each of said players deciding whether to place an additional bet into said pot, wherein each of said players who decides to place said additional bet is eligible to continue playing;
indicating to said players which players have decided to place said additional bet into said pot only after all of said players have decided;
repeating said dealing, deciding and indicating steps until only one of said players has decided to place said additional bet or said game is concluded;
awarding said pot to one of said players when all other players have decided not to place an additional bet, or awarding said pot to one or more of said players having the best poker hand at the conclusion of said game.

51. A method of playing a poker game over a communication network with a plurality of players comprising the steps of:
placing a first bet into a pot by each of said players;
dealing one or more cards from a deck of poker playing cards for said players;
providing a time interval for placing an additional bet into said pot by each said players;
placing said additional bet by said players wherein each of said players who place said additional bet continue to participate in said game and wherein each of said players who do not place said additional bet stop participating in said game;
repeating said dealing, providing and placing additional bet steps until there is a sole player who places said additional bet or until said hand is completely dealt;
awarding said pot to said sole player or to said player who has a best hand after said hand is completely dealt.

52. A method of playing a poker game over a communication network with a plurality of players comprising the steps of:
placing a first bet into a pot by each of said players;
displaying on a monitor for each player one or more cards for said players;
each of said players deciding whether to place an additional bet into said pot, wherein each of said players who decides to place said additional bet is eligible to continue playing;
indicating to said players on said monitors which players have decided to place said additional bet into said pot only after all of said players have decided;
repeating said displaying, deciding and indicating steps until only one of said players has decided to place an additional bet or said game is concluded; and
having one of said players receive said pot when all other players have decided not to place an additional bet, or when said player has the best complete poker hand at the conclusion of said game.

53. A method of playing a poker game over a communication network with a plurality of players comprising the steps of:
placing a first bet into a pot by each of said players;
displaying on a monitor one or more cards from a deck of poker playing cards for said players;
providing a time interval for placing an additional bet into said pot by each of said players;
allowing each of said players who placed said additional bet into said pot to continue to participate in said game and not allowing any player who did not place an additional bet in said pot to continue to participate in said game;
repeating said displaying, providing and allowing steps until there is only a single player participating in the game or until said hand is completely dealt; and
receiving of said pot by said single player, or by the player with the best hand after said hand is completely dealt.

54. A method of playing a poker game over a communication network with a plurality of players comprising the steps of:
displaying on a monitor one or more cards from a deck of poker playing cards for said players;
providing a time interval for placing a bet into said pot by each of said players;
allowing each of said players who placed said bet into said pot to continue to participate in said game and not allowing any player who did not place a bet in said pot to continue to participate in said game; and
repeating said displaying, providing and allowing steps until there is only a single player participating in the game or until said hand is completely dealt.

55. The method of claim 54, further comprising the step of permitting an ante bet to be placed into a pot by each of said players prior to said displaying step.

56. The method of claim 54, further comprising the step of giving of said pot to said single player, or to the player with the best hand after said hand is completely dealt.

57. The method of claim 54, further comprising the step of indicating which players have placed said bet into said pot.

58. The method of claim 57, wherein said indicating step takes place only after all of said players decide whether to place said bet.
